(19) United States
(12) Patent Application Publication
(10) Pub. No.: US 2025/0100321 A1
(43) Pub. Date: Mar. 27, 2025

(54) METHOD FOR PRODUCING DECORATIVE COMPONENTS

(71) Applicant: SWISS KRONO Tec AG, Luzern (CH)

(72) Inventor: Sebastian Dicke, Bantikow (DE)

(21) Appl. No.: 18/729,735

(22) PCT Filed: Jan. 20, 2023
(86) PCT No.: PCT/EP2023/051376

§ 371 Date: Jul. 17, 2024

(30) Foreign Application Priority Data
Jan. 24, 2022 (EP) 22152863.1

(51) Int. Cl. B44C 5/04

(52) U.S. Cl. CPC B44C 5/043

(57) ABSTRACT

The disclosure relates to a method for producing decorative components which have a planar core, preferably made of wood-based material, and a printed paper, the method includes: printing a decoration on a substrate using a digital printing system, the decoration having a decoration length and a decoration width; further processing the printed substrate such that decoration sheets are produced, the dimensions of which correspond to those of the core; pressing each decoration sheet with a core; and dividing the core provided with the decoration sheet into a plurality of decorative components, the decoration length being at least as long as two decoration components, the decoration length being at least as long as two cores, and the decoration being enlarged by adding digital prototypes so that the decoration length is enlarged.

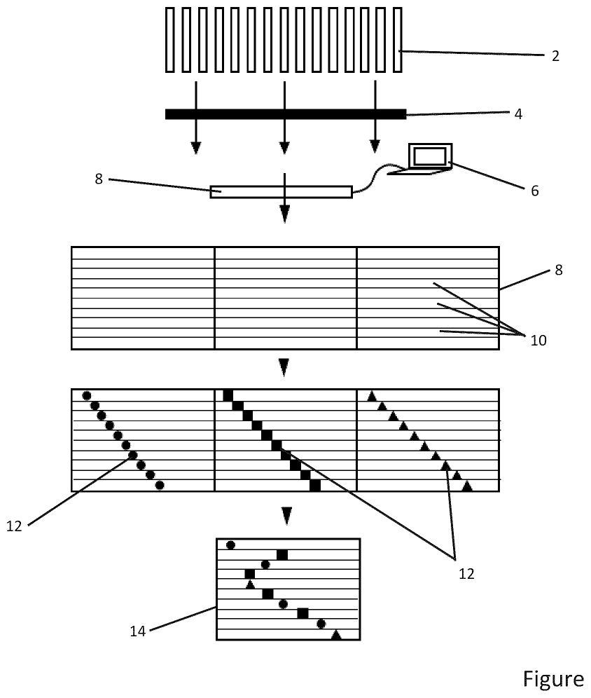

### FIELD OF INVENTION

The invention relates to a method for producing decor components which have a planar core, preferably made of a wood-based material, and a printed substrate, the method comprising the following steps:
printing a decor onto a substrate by means of a digital printing facility, the decor having a decor length and decor width,
further processing the printed substrate, thus obtaining decor sheets, the dimensions of which correspond to those of the core,
pressing each decor sheet with a core and
dividing the core provided with the decor sheet into a plurality of decor components, wherein the decor length is at least as long as two decor components.

### BACKGROUND

Such methods have been known from the prior art for many years and are used to produce various decor components. This includes, for example, laminate panels, which can be used as a floor, wall or ceiling covering, as well as panel-like decor components which are used, for example, to produce furniture or other items.

In many embodiments, the printed substrate is a paper web onto which the desired decor is printed. In general, once the decor has been printed onto the printed substrate, the printed substrate is bonded with the core, for example by pressing, and then divided along with the core, thus obtaining the desired decor components. Consequently, a decor component has smaller dimensions than the core with which the printed substrate is bonded. Accordingly, the decor is also larger than the decor component. The decor generally consists of multiple, for example 8, 10 or 12, individual decors, which correspond to the same number of decor components. Each decor component is therefore provided with an individual decor.

When producing laminate panels that are to serve as floor panels, a decor is usually printed onto paper webs. This is often done by means of print rollers, for example in rotary printing. There is an upward limit to the dimensions of the print rollers, as increasing the size of the print rollers also results in an increase in weight. The print length, which is stipulated by the circumference of the print rollers and corresponds to the decor length, is also limited. The surface area of the lateral surface of the print rollers corresponds to the printing surface and thus to the surface of the decor that can be used for the decor components.

Nowadays, printed substrates are also printed with digital printing facilities that no longer contain print rollers. The decor that is printed onto the printed substrate is contained in a print file, which also usually contains control commands and printing parameters that are transferred to the digital printing facility. The dimensions of the decor contained therein correspond to those known from roller printing or rotary printing.

In the case of laminate floor panels in particular, the aim is often to recreate and give the visual impression of real wood panels. This means that repetitions in the decor are a disadvantage, as they do not naturally occur. In rotary printing, a larger range of individual decors, i.e. the decors on the decor components, can now be achieved by using different print rollers. In this process, the decor of a first print roller is first printed in a predetermined display and the corresponding decor components are produced. The print roller is then changed and the decor of the second print roller printed. The decor components produced in this way have to be temporarily stored and then mixed in order to be able to be packed in packages or bundles that contain a range of individual decors and, as far as possible, contain no individual decor repetitions. The process is similar in digital printing. First, a first decor is printed in a predetermined display so that a first set of decor components is produced in said predetermined number. A second set of decor components is subsequently printed by likewise printing a second decor in a predetermined display and mixing the resulting decor components with the decor components that feature the first decor. This is complex as well as time and cost-intensive.

### SUMMARY

The invention thus aims to further develop a method for producing decor components in such a way that a wider variety of decors can be achieved.

The invention solves the task addressed by way of a method according to the preamble of claim 1, which is characterized in that the decor length is at least as long as two cores and the decor is enlarged by adding digital master samples, thus increasing the decor length. Preferably, the decor length is at least as long as three, preferably four, particularly preferably six, decor components.

The invention is based on the knowledge that the limitation of the size of the decor originating from rotary printing does not exist, or at least not to the same extent, in a digital printing facility. The size of the decor contained in the print file and transferred to the digital printing facility is essentially limited by the maximum size of the print file that can be processed and managed by the electrical control unit, such as an electronic data processing device, of the digital printing facility. The decor length is preferably larger than the decor width. The length of the decor components is preferably larger than the width of the decor components.

The decor may be designed as a fantasy decor. However, the decor components should often give the impression that they have been produced from a certain material, such as wood or stone. This is intended to enhance the decor component and give it a more expensive and high-quality appearance. For example, the impression of real wood boards or large stone panels can be created without the need to actually use these expensive materials and components. For many of these impressions to be created, it is advantageous or even important that the parts of the decor that are positioned on the different decor components do not fit together seamlessly, or not between all decor components. For example, a floor would look odd if all the laminate panels that are laid, which in this case are the decor components, featured a decor that merged seamlessly in both the longitudinal and transverse direction of the panels. One would have the impression that the entire floor was made of a single wooden panel. This is unrealistic and usually not wanted.

The decor components produced in the method according to the present invention are generally not positioned in the same arrangement as they are arranged next to each other as part of the printed substrate or decor sheets. If the decor printed onto the printed substrate contains at least one reproduction of a real decor, which is preferably larger than the part of the decor arranged on individual decor components, this at least one reproduction is applied to the printed substrate in such a way that the parts of the decor that are positioned on adjacent decor components adjoin each other and preferably do not show any transition. In particular, it is not necessary and often poses a disadvantage to process, divide and sort the reproduction of a real decor in such a way that the decor continues across various decor components when they are positioned in their final arrangement in relation to each other. Given that this is not necessary according to the present invention, processing time and effort can be saved, rendering the method cheaper.

In one preferred embodiment, the decor comprises multiple reproductions of a natural decor, each of which is larger than each of the decor components to be produced. Preferably, at least one, but preferably every reproduction is as large as a decor sheet or an integral multiple thereof.

The decor is preferably electronically stored in a print file, which is transferred to the digital printing facility and used to control the digital printing facility. Alternatively, the decor is divided up on multiple such print files, which are transferred to the digital printing facility and used to control the digital printing facility. In this case, the multiple print files are used in combination to control the digital printing facility. It is not provided for to first print the part of the decor stored in a first print file in a predetermined display before another part of the decor stored in a second print file is printed. If the decor is split across multiple print files, these corresponding parts of the decor are printed in succession. In this way, the part of the decor stored in the first print file is printed once. The part of the decor stored in a second print file is then printed once. This continues until every part of the decor has been printed once. The method is then repeated.

Preferably, the decor length is at least as long as two, preferably three, particularly preferably four, cores. The length of the core is preferably as long as two, particularly preferably three, decor components.

In one preferred embodiment, multiple decors that differ from one another are printed onto the printed substrate. Each of these decors then corresponds, for example, to a partial decor and is preferably stored in a separate print file, which is transferred to the digital printing facility. In this case too, the various print files are transferred such that they are used in combination to control the digital printing facility.

Preferably, the printed substrate is a paper web. It is normally provided as a paper roll and used an a “continuous” paper web. Alternatively, the paper web can also be provided in the form of individual paper sheets, wherein the length of one paper sheet preferably corresponds to the length of the decor. The same applies when the decor is composed of multiple partial decors. Alternatively, it can be especially advantageous when using individual paper sheets for the length of one paper sheet to correspond to the length of one partial decor.

The decor components produced using the method described here are preferably laminate panels. Preferably, the printed substrate, particularly preferably the printed paper web, is impregnated and cut to size during further processing, thus obtaining printed and impregnated decor paper sheets which form the decor sheets for the further method.

After production, the decor components are packed into packages in such a way that only different decor components are contained within one package. This ensures that, when the decor components are used, for example as floor panels, the decor components combined and packed in a package do not lead to a repetition of the individual decor.

It is particularly preferable to pack the decor components produced in a plurality of packages, any given two of which contain different decor components. Each decor component features an individual decor that constitutes part of the decor. If any given two of the packages contain different decor components, this means that the individual decors of the decor components of the first package are not included in the decor components of the second package and vice-versa. This design ensures that the use of the decor components from a plurality of packages does not lead to the repetition of a motif. The plurality of packages preferably refers to at least four, preferably at least six, especially preferably at least ten packages.

The decor is preferably enlarged by adding digital master samples, thereby increasing the decor length. Digital image processing and digital image editing renders it possible to retrospectively modify the decor and increase the decor length. This was not possible with roller printing or rotary printing. For example, if further individual decors are to be added to the decor, additional master samples, such as real wood patterns, are digitally recorded and mapped, for example. These digital images are then added to the decor in digital form, i.e. the decor is enlarged. The decor length then no longer corresponds to the length of four decor components, for example, but to the length of five decor components.

The decor components preferably have a length of at least 100 cm, preferably at least 115 cm, particularly preferably at least 130 cm and at most 280 cm, preferably at most 200 cm and particularly preferably at most 150 cm.

In a specific embodiment, the method is performed in the following manner:

First of all, the decor is digitalized, for example by generating digital data. A scan or photo of a motif, such as a real wood decor, a real stone decor or another decor, can be generated. In principle, the number of digital images created in this manner is only limited by the amount of memory that can be managed and processed by the electrical control unit. The actual decor is subsequently created using image editing software by combining multiple digital images and combining them to create a decor. The print width is determined by the width of the decor generated in this manner.

The print data length is likewise limited by the quantity of data transferred or the file size. For example, in the case of a pdf file and a length of 5080 mm, it can be 1,080,000,000 data points. Up to this limit, which can vary greatly depending on the electric control unit and the digital printing facility, the variety of individual decors can be further increased. In principle, it is also possible to increase the variety of said individual decors beyond this extent. In this case, multiple print files with the partial decors contained within are used, the latter being numbered 1, 2, 3, for example. These are then preferably printed in the order 1,2,3,1,2,3,1,2,3.

The decor, which is transferred in a print file or multiple print files to the electrical control unit of the digital printing facility, does not have to be printed in full. In some embodiments, only a section of the transferred decor is printed, wherein the section can be selected almost freely. It is only important that the printed section is large enough for all decor components produced to feature one individual decor. This also renders it possible to avoid repetition of a motif and to almost limitlessly increase the variety of the individual decors.

The decor that is transferred to the digital printing facility can be stored in one or multiple files, wherein the partial decors contained therein are continuous in length and can be printed without visible transitions. Alternatively, the printed image may contain an edge depending on the dimensions, in particular the length, of the decor components to be produced. For example, if laminate floor panels with a length of 140 cm are produced, there is an edge in the decor at 140 cm intervals in the printed image.

The decor can also contain control characters or quality defects, which are placed in the print data or during printing and which are read during further processing and are helpful for allocating the individual decor components and sorting them into packaging units.

In one further specific embodiment example, a producer of laminate floorboards has to date printed all decors using rotary printing with a maximum roller circumference of 1860 mm. The print width is 205 cm. The maximum print surface, which can also be referred to as the area of decor variety, is therefore 186 cm×205 cm (approx. 3.8 m²) and corresponds to 10 floorboards, for example. To celebrate a company anniversary, it was decided to add an oak decor to the collection which is to expand every year in terms of the variety of boards. A particularly large amount of natural material was provided for the digitalization process. Two partial decors, each with a length of 372 cm, i.e. 744 cm in total, will be created for the new inclusion of this decor. They will be stored in two print files and transferred to the electrical control unit of the digital printing facility. They will be used in combination, which means that their partial decors will preferably be printed in direct succession. For the producer's customers, this means a board variety of 744 cm: 186 cm×10 board, which corresponds to 40 boards. By using the method according to an embodiment example of the present invention, the variety of decors could thus be increased from 3.8 m² to over 15 m². For every additional year that the producer exists, it is planned to expand the decor by a further print file for this decor. This means that the variety of the decor will grow by a further 3.8 m² each year. In this case, the variety of decor is the area that can be covered with floor panels featuring this decor without the decor being repeated.

In the following, a further specific embodiment example will be described: In the USA, the standard print width for decors in industrial floorboard production is “only” 1400 mm. To date, one producer has printed all decors using rotary printing with a roller circumference of 1300 mm. The print surface, i.e. the variety of decor, of 140 cm×130 cm corresponded to seven individual floorboards.

Five partial decors, each with a length of 390 cm, i.e. 1950 cm in total, will be created for the new inclusion of a decor. They will be printed one after the other and the printed substrate further processed. For the producer's customers, this means a board variety of 1950 cm: 130 cm×7 boards, which corresponds to 105 boards. After further processing, the variety of decor could be increased from approximately 1.8 m² to over 24 m². This is enough to furnish a number of normal living rooms without repeating the decor.

In the following, a further embodiment example will be described in detail: A wood decor is produced on a paper digital printing facility with a working width of 2070 mm at a paper speed of 135 m/min. The paper is a White decor paper with a grammage of 65 g and a water-based ink is used. The color system corresponds to the CRYK system. A primer is applied inline at a rate of 3 g/m². The wood decor has a print length of 4200 mm and a width of 2070 mm. The laminate board obtained after further processing is 1400 mm×193 mm. This means a range of 30 different boards for this decor. To ensure that this variety is also reflected in the subsequent packaging, markings are made in the print files in advance so that the individual boards that will be produced later can be assigned. For example, each board receives a number from 1 to 30 which, by means of software, is embedded into the separations in such a way that it is invisible to the human eye, but which can be detected by optical measurement devices and image recognition software. The packaging size in this embodiment example is 10 boards per package. Once the decor components have been produced and the lateral edges profiled, they are sorted during packaging in such a way that all 30 different boards are contained in three consecutive packaging units.

Preferably, the side of the core or decor components that features the decor sheet is given a structure so that it not only visually matches the decor, but also in terms of the haptic impression. To this end, the object provided with this structure is preferably fed to a press in which the structure is embossed into the surface. The press preferably has at least one press plate, which may also be designed as a press roller and has a three-dimensional surface with elevations and/or depressions that are adapted to the motif of the decor.

Preferably, at least one part of the decor, especially preferably the entire decor, is adapted to a structure of a press plate. In the process, the digital data of the structure and the decor are first provided. The decor is then adapted to the structure by processing the digital data of the decor, wherein at least one first area of the decor is brought to coincide precisely with the structure and at least one second area of the decor, which is not brought to coincide exactly with the structure, is visually covered by means of computer-aided processing. This method allows a decor component, such as a floor panel, to be produced that has a structure on at least one side and a decor motif adapted to said structure.

Preferably, the digital data of a structure, such as a wood or stone grain, are provided. The data can be provided directly as a digital data set of a press plate or by means of scanning a corresponding structure or even generated by inputting the data. In principle, digital data of the structure can be provided in any manner. This data set contains information on forming a structure for at least one side of the decor component or the core provided with the decor sheet, wherein the data preferably contain lines, dots or other structure-forming area boundaries. Preferably, the digital data for processing enable a three-dimensional depiction or application of the surface structure, so that the structure can be represented and/or applied in its individual planes. As a result, the processing or adaptation of the decor motif can preferably be performed by area in each individual area or plane of the same structural depth.

Preferably, the digital data of the structure provided are configured in such a way that a growth of the decor that they are to match is taken into account. The dimensions of the structure described by the digital data are preferably larger than the dimensions of the decor. This enables, for example, expansions of the printed paper caused by heat, for example from the press used, and/or by the pressure to be applied during pressing and/or by the impregnation of the paper to be taken into account.

It is therefore possible to process individual areas independently of the entire decor motif or the entire structure. The sample of the decor motif is also provided as a digital data set. The methods known from the prior art for providing data by scanning or entering the corresponding data can also be used for this purpose. According to invention, the digital data of the decor are adapted to the data of the sample that provides the structure by means of computer-aided processing. In the process, the digital data of the decor are adapted in such a way that the decor overlays the structure in the largest possible matching area. As a result, at least one first area of the motif or decor can be brought to coincide exactly with the structure, so that the decor precisely matches the structure in this area without post-processing. In the area where the decor does not precisely match the structure, the second area, the decor deviates from the structure. This second area is visually covered by means of computer-aided processing in a subsequent step.

This means that the second area of the decor is processed using various techniques in such a way that an adaptation of the decor motif to the structure and/or a modification of the motif is achieved such that the observer has the visual impression that the decor matches the structure. The result is a purely visual match. This can be enabled, for example, by brightening or darkening the non-matching area. In this way, various decors can be directly adapted to the structure of the press plate. Consequently, both the number of intermediate steps in the production of such a decor component and the number of press plates required for various decors is reduced. Panels with a structure and different decors can be produced easily and cost-effectively, even in relatively small series.

The adaptation of the decor to the structure is preferably achieved by capturing and overlaying the decor and the structure, geometric transformation, image distortion and image offset, correcting line, color, brightness and/or contrast, removing and/or swapping certain image elements. Each of these techniques can be applied in a partial area or across the entire decor. To this end, known software products that are suitable for digital image processing can be used.

Alternatively or additionally, the decor is adapted to the structure by performing a sample print of the decor on a paper and pressing this printed paper with a core, wherein the structure is embossed into the decor component. A visual check, for example by optical machine detection of structure and decor and comparison of structure and decor by means of an electrical control unit, can determine a corrective measure which adapts the decor to the structure.

Preferably, when adapting the decor to the structure, a corresponding decor element or a corresponding color from a selection is chosen for the second area as an optical covering element and inserted into the corresponding area of the decor. Similar, comparable or recurring deviations of the decor from the structure are preferably categorized and/or catalogued, so that such similar areas or defect areas that do not match precisely can be quickly and easily covered by selecting a suitable decor element.

The structure of the press plate can be generated in advance by means of a reference decor or adapted to such a decor. For example, the digital data of the structure can be adapted to the digital data of a reference decor. It is thus possible to first generate a structure using a sample, decor or reference decor, on the basis of which the further decors are constructed according to the method given above. The reference decor can thus be used as a template for the corresponding structure and therefore for the various decors.

The provision of the digital data of the decor prior to image processing is preferably done by scanning a sample, for example a wood or stone grain or another decor motif. Preferably, naturally occurring finishing materials are used as samples; however, any other motif or artificially generated image or text can also be applied. For example, the texture of a lettering can be provided on a panel as a structure and decor. The decor or sample is digitalized by means of scanning and provided for computer-aided processing.

It is preferably possible to adapt multiple different decors to a structure. For example, the decors may exhibit differences in wood type, color or other imaging elements, whereas in other elements they are identical, such as a grain. As a result, it is possible to apply an unlimited number of different decors or motifs to produce panels with the same structure. As such, the production of various panels only requires one structure-forming press plate, so that the costly production and storage of different press plates can be avoided. The result is a broad selection of different decor panels that have the same structure.

The provision of the digital data of the structure is achieved by scanning or capturing a surface structure on a press plate. Alternatively, a surface structure formed on a sample or panel can also be used to scan or capture the structure data. The structure is preferably captured in 3D. In a subsequent step, the decor motif is adapted to these digital data of the existing surface structure. This makes it possible to use an already formed surface structure for processing the decor motif with dimensional accuracy. This enables a large area where the decor matches the structure and reduces the number of non-matching areas.

Preferably, the structure and/or the decor represents a wood grain, such as wood veins, wood holes and/or wood pores. This enables a relatively simple and cost-effective reproduction of real wood panels. According to the invention, the wood grain elements depicted in the decor are adapted to the structure by means of computer-aided processing.

Preferably, two or more digital images of different samples or decors are adapted to a structure. As a result, it is possible to apply different decor motifs for the production of decor elements, wherein only one press plate is required. The production of structure-forming press plates is relatively expensive, so that the present invention enables a considerable reduction in the cost of producing panels with various decor motifs.

In one preferred embodiment, the decor is composed of multiple partial decors, each of which preferably has the dimensions of a core. It is particularly preferable if some of these partial decors, but preferably all of these partial decors, are adapted to the same structure of a press plate which, in an especially preferred embodiment, has the dimensions of a core.

### BRIEF DESCRIPTION OF DRAWINGS

In the following, an embodiment example of the invention will be explained in more detail with the aid of the accompanying FIGURE. It shows

The FIGURE shows a schematic sequence of a method according to an embodiment example of the present invention.

### DETAILED DESCRIPTION

The FIGURE schematically depicts the sequence of a method of the type described here. Firstly, a scan template 2 is used, from which digital images are to be generated. A scanner 4 is used for this purpose. In this way, a digital image of each element of the scan template 2 is generated. Said images are combined in an electrical control unit 6 which, in the embodiment example shown, is a computer, in particular a laptop, to create a decor 8.

The decor 8 comprises a plurality of individual decors 10, of which three are shown next to each other and ten on top of each other in the embodiment example shown. They correspond in size and shape to the decor components to be produced. In addition to the individual decors, markings 12, which are in the form of a circle, square and triangle in the embodiment example shown, are also used. The type of marking 12 encodes whether the respective decor component to be produced has been provided with an individual decor from the left-hand (circle), middle (square) or right-hand (triangle) area. The position of the respective marking 12 depicts the position of the individual decor in this area. In each case, ten decor components are grouped and packaged in a bundle 14. The markings 12 ensure that a bundle 14 only contains different individual decors.

1. A method for producing decor components comprising a planar core made of a wood-based material, and a printed paper, the method comprising:
printing a decor onto a substrate by use of a digital printing facility, the decor having a decor length and decor width,
further processing the printed substrate, thus obtaining decor sheets, dimensions of which correspond to the core,
pressing each decor sheet with a core, and
dividing the core provided with the decor sheet into a plurality of decor components, wherein the décor length is at least as long as two decor components,
wherein the decor length is at least as long as two cores and the decor is enlarged by adding digital master samples, thus increasing the decor length.

2. The method according to claim 1, wherein the decor length is at least as long as three decor components.

3. The method according to claim 1, wherein the decor is contained in a print file or multiple print files, which are transferred to the digital printing facility and used to control the digital printing facility.

4. The method according to claim 1, wherein the decor length is at least as long as three cores.

5. The method according to claim 1, wherein multiple decors, which differ from each other, are printed onto the printed substrate.

6. The method according to claim 1, wherein the decor components are packed into packages in such a way that one package only contains different decor components.

7. The method according to claim 6, wherein the decor components are packed into a plurality of packages, any given two of which contain different decor components.

8. The method according to claim 1, wherein laminate panels have a length of at least 100 cm and at most 280 cm.

9. The method according to claim 1, wherein the decor length is at least as long as four decor components.

10. The method according to claim 1, wherein the decor length is at least as long as six, decor components.

11. The method according to claim 1, wherein the decor length is at least as long as four cores.

12. The method according to claim 1, wherein laminate panels have a length of at least 115 cm and at most 280 cm.

13. The method according to claim 1, wherein laminate panels have a length of at least 130 cm and at most 280 cm.

14. The method according to claim 1, wherein laminate panels have a length of at least 100 cm and at most 200 cm.

15. The method according to claim 1, wherein laminate panels have a length of at least 115 cm and at most 200 cm.

16. The method according to claim 1, wherein laminate panels have a length of at least 130 cm and at most 200 cm.

17. The method according to claim 1, wherein laminate panels have a length of at least 100 cm and at most 150 cm.

18. The method according to claim 1, wherein laminate panels have a length of at least 115 cm and at most 150 cm.

19. The method according to claim 1, wherein laminate panels have a length of at least 130 cm and at most 150 cm.
